(19) United States
(12) Patent Application Publication
(10) Pub. No.: US 2025/0217697 A1
(43) Pub. Date: Jul. 3, 2025

(54) EFFICIENT EXECUTION OF MACHINE LEARNING MODELS BASED ON SPARSE DICTIONARIES

(71) Applicant: QUALCOMM Incorporated, San Diego, CA (US)

(72) Inventors: Ravishankar SIVALINGAM, San Jose, CA (US); Vishwas DIWAKARA, San Diego, CA (US); Ravindra Vaman SHENOY, Dublin, CA (US)

(21) Appl. No.: 18/402,051

(22) Filed: Jan. 2, 2024

(51) Int. Cl. G06N 20/00

(52) U.S. Cl. CPC G06N 20/00

(57) ABSTRACT

Techniques and apparatus for efficiently executing inferencing operations using machine learning models are provided. An example method generally includes loading, into a first memory, a dictionary associated with at least a portion of a machine learning model and a first coefficient matrix associated with a first portion of the machine learning model. A first intermediate output associated with the first portion of the machine learning model is generated based on an input into the at least the portion of the machine learning model, the dictionary, and the first coefficient matrix. The first and second coefficient matrices are swapped between the first and second memories. A second intermediate output associated with the second portion of the machine learning model is generated based on the input into the at least the portion of the machine learning model, the first intermediate output, the dictionary, and the second coefficient matrix.

### INTRODUCTION

Aspects of the present disclosure relate to machine learning models, such as generative artificial intelligence models, and more specifically to efficient execution of operations using such models.

Generative artificial intelligence models can be used in various environments in order to generate a response to an input query. For example, generative artificial intelligence models can be used in chatbot applications in which large language models (LLMs) are used to generate an answer, or at least a response, to an input query. Other examples in which generative artificial intelligence models can be used include stable diffusion and other text-to-image models, in which a model generates an image from an input text description of the content of the desired image, and decision transformers, in which future actions are predicted based on sequences of prior actions within a given environment.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., word or part of word) generated as part of the response. The output of each pass may be a probability distribution on a set of tokens (e.g., words or parts of words) from which the next token (e.g., word or part of word) may be selected, either by sampling or based on maximum likelihood, for example. Because a pass through a large language model is used to generate each word (or token(s)) in a response to a query, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a method for efficiently executing operations using machine learning models. The method generally includes loading, into a first memory, a dictionary associated with at least a portion of a machine learning model and a first coefficient matrix associated with a first portion of the machine learning model. A first intermediate output associated with the first portion of the machine learning model is generated based on an input into the at least the first portion of the machine learning model, the dictionary, and the first coefficient matrix. The first coefficient matrix is swapped out of, and a second coefficient matrix is swapped into, the second memory, the second coefficient matrix being associated with a second portion of the machine learning model. A second intermediate output associated with the second portion of the machine learning model is generated based on the input into the at least the first portion of the machine learning model, the first intermediate output, the dictionary, and the second coefficient matrix.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example decomposition of a weight matrix associated with a portion of a machine learning model into a dictionary and a coefficient matrix, according to aspects of the present disclosure.

FIG. 2 illustrates swapping of coefficient matrices between on-processor and off-processor memory, according to aspects of the present disclosure.

FIG. 3 illustrates example operations for efficiently executing machine learning model operations using a dictionary and a coefficient matrix associated with a portion of a machine learning model, according to aspects of the present disclosure.

FIG. 4 illustrates an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently executing inferencing operations using machine learning models, such as generative artificial intelligence models.

Generally, machine learning models, such as generative artificial intelligence models, generate a response to an input into the model based on weights associated with various parameters within the model. Because of the size of these models, machine learning models may not fit within on-processor memory (e.g., static random access memory (SRAM) associated with a processor on which a machine learning model operates, such as various on-processor caches). Thus, the inferencing throughput of these machine learning models may be limited by the bandwidth of off-processor memory (e.g., dynamic random access memory (DRAM) used for temporary storage of data, swap space, persistent storage, etc.). Because operations generally may not execute until the data involved in an operation is swapped into on-processor memory, swapping data into and out of on-processor memory may introduce significant latencies into inference operations using a machine learning model and thus degrade the performance of these inference operations and of the computing device on which such operations are performed (e.g., by increasing power utilization, reducing battery life, etc.).

In some cases, such as in generating responses to queries using a generative artificial intelligence model, the arithmetic complexity involved in generating tokens to be included in a response to these queries may be relatively low compared to the cost of transferring weights from off-processor memory to on-processor memory. Thus, the upper bound on the throughput (e.g., token generation rate) may be represented by the expression:

$$Throughput \leq \frac{DRAMBandwidth}{Precision \times ModelSize}$$

Thus, to increase the throughput of these machine learning models, the numerator may be increased, or the denominator may be decreased. For any given hardware configuration, however, the DRAM (off-processor) memory bandwidth may be fixed, and the cost and power consumption metrics associated with higher-bandwidth memory (e.g., high bandwidth memory (HBM) or other types of on-processor memory) may make it impractical for use in cost-constrained or power-constrained environments (e.g., on mobile devices with limited available power when disconnected from mains power). While reductions in precision (e.g., via quantization from larger, more complex data types to smaller, less complex data types, such as from 32-bit floating point to 8-bit integer) and the size of the model may allow for an increase in model throughput, such reductions may have a negative effect on inference accuracy.

Aspects of the present disclosure provide techniques for efficiently executing inferencing operations using machine learning models, such as the generation of responses to a query input into a generative artificial intelligence model. Generally, execution of the generative artificial intelligence model may be performed based on a decomposition of a dense weight matrix for at least a portion of a machine learning model into a dictionary and a coefficient matrix. The dictionary may be reused across different portions of the machine learning model (e.g., used for generating weights associated with different layers of the machine learning model), and the coefficient matrix may be swapped into and out of on-processor memory on an as-utilized basis (e.g., as different layers in a machine learning model are executed). By reducing the amount of data swapped between on-processor memory and off-processor memory, aspects of the present disclosure may increase the throughput of machine learning models (e.g., increase the number of inferences these machine learning models can perform over a given period of time), such as generative artificial intelligence models or other models with performance characteristics that are memory-bandwidth-limited. Further, because the amount of data swapped into and out of on-processor memory may be significantly reduced relative to the amount of data associated with a dense weight matrix in its entirety, aspects of the present disclosure may reduce latencies involved in executing inferencing operations based on such dense weight matrices and allow for computing resources to be made available for other operations instead of being wasted while data is swapped into and out of on-processor memory.

### Decomposition of Dense Weight Matrices into a Dictionary and a Coefficient Matrix

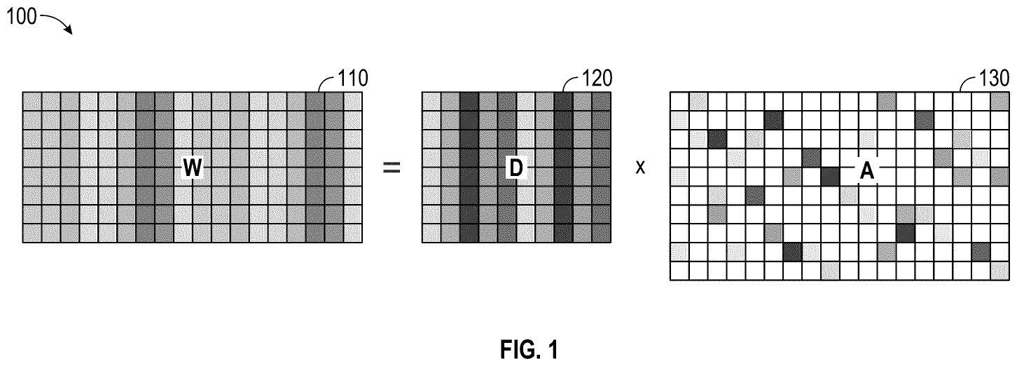

FIG. 1 illustrates an example decomposition 100 of a weight matrix associated with a portion of a machine learning model into a dictionary and a coefficient matrix, according to aspects of the present disclosure.

Generally, a weight matrix W 110 may include the weights of a machine learning model stacked into a matrix including a number of rows corresponding to a number of embedding dimensions dₘ and a number of rows corresponding to the product of at least dₘ and the number of layers L in the machine learning model. In some aspects, such as in generative artificial intelligence models including a number of self-attention heads, the number of rows may be further based on the number of self-attention heads in the model (e.g., a factor of 12 using multi-head attention and a two-layer feedforward network with non-gated-linear-unit nonlinearities). In some aspects, vocabulary and/or positional embeddings may further be appended to the weight matrix W 110. In one example, where the machine learning model is a transformer-based model including a number of feedforward networks, the weight matrix W 110 may thus be represented by the expression:

$$W = [ {W}_{q}^{0} \vert … \vert {W}_{q}^{l} \vert {W}_{k}^{l} \vert {W}_{v}^{l} \vert {W}_{o}^{l} \vert {W}_{ffn \_ 1}^{l} \vert {W}_{ffn \_ 2}^{l} \vert … \vert {W}_{ffn \_ 2}^{L - 1} ]$$

where q represents query inputs into the l^{th} of L layers in the transformer-based model, k represents key data in the l^{th} of L layers the transformer-based model, v represents values associated with the key data k, o represents an output of the l^{th} of L layers in the transformer-based model, and ffn_x represents data associated with the x^{th} feedforward network in the transformer-based model.

Generally, the weight matrix W 110 is substantially larger than the amount of on-processor memory on one or more processors on which inferencing operations execute. For example, for a model trained based on 13 billion parameters stored as 16-bit floating-point data, the weight matrix W 110 may have a size of 26 gigabytes. The resulting latency of inferencing operations using this machine learning model may thus be bounded by the size of the model (e.g., 26 gigabytes in this example) and the bandwidth of the off-processor memory in the computing system on which the machine learning model operates. While increasing the batch size, or the number of tokens generated during each round of inferencing operations, may increase the total number of tokens generated over time, the rate at which these tokens are generated may still remain memory-bandwidth limited.

To reduce the memory overhead associated with inferencing operations using machine learning models defined by dense weight matrices, such as the weight matrix W 110, aspects of the present disclosure may decompose the weight matrix W 110 into a dictionary D 120 and a coefficient matrix A 130. The dictionary D 120 may have a size of dₘ×R, where R is a variable that controls the dictionary size, and the coefficient matrix A 130 may have a size of R×12×L×dₘ, where the factor of 12 is associated with the structure of a model using multi-head attention and a two-layer feedforward network with non-gated-linear-unit nonlinearities as discussed above. Generally, different coefficient matrices may be established for different portions of the machine learning model. For example, different coefficient matrices may be established for different layers in the machine learning model.

In some aspects, the coefficient matrix A 130 may be represented by the expression:

$$A = [ {A}_{q}^{0} \vert {A}_{k}^{0} \vert {A}_{v}^{0} \vert {A}_{o}^{0} \vert {A}_{ffn \_ 1}^{0} \vert {A}_{ffn \_ 2}^{0} \vert … \vert {A}_{ffn \_ 2}^{L - 1} ]$$

That is, the coefficient matrix A 130 for a transformer-based neural network may include coefficient sub-matrices for each layer in the neural network and for different components within each layer. For example, in the first layer of the neural network (denoted as index 0), different coefficient submatrices may be established for query data, key data, value data, outputs, and different feedforward networks within the first layer. This establishment of different coefficient submatrices may be repeated for each layer in the neural network.

To generate the dictionary D 120 and the coefficient matrix A 130, various decomposition techniques may be used based on a defined dictionary size R selected so that the dictionary D fits into on-processor memory (e.g., SRAM). The value of R may also be chosen such that the resulting dictionary D 120 is overcomplete, or includes more dictionary vectors than are called for to uniquely represent an N-dimensional vector, where N corresponds to an average number of non-zero coefficients in a column of the coefficient matrix A 130. For example, in some aspects, R may be chosen such that R≈2×dₘ. In some aspects, the dictionary D 120 and the coefficient matrix A 130 may be generated based on sparse decomposition of the weight matrix W 110 into a small dictionary D 120 and a small coefficient matrix A 130. In some aspects, low-rank decomposition techniques, such as singular value decomposition (SVD), may be used to generate the dictionary D 120 and the coefficient matrix A 130. In doing so, the weight matrix W 110 may be decomposed into the product of two dense orthogonal matrices, U and V. In some aspects, low-rank decomposition and sparse decomposition techniques may be combined in order to generate the dictionary D 120 and the coefficient matrix A 130. In doing so, the weight matrix W 110 may be decomposed into a sum of a low-rank matrix L and a sparse error matrix S. The low-rank matrix L may be decomposed into the product of the dense orthogonal matrices U and V, and the error matrix S may be stored as a sparse matrix. Generally, multiple decomposition techniques may be combined to reduce the memory footprint of the coefficient matrix A 130 to minimize, or at least reduce, the amount of data swapped into and out of on-processor memory and thus correspondingly increase inference throughput for the machine learning model.

Generally, the dictionary D 120 may have dimensions of dₘ×R and may be loaded into SRAM once during execution of inferencing operations using the machine learning model. Generally, the average number of non-zero coefficients N in each column of the coefficient matrix A 130 may be smaller than the dimensionality dₘ of the machine learning model. In some aspects, the dictionary D 120 may be fine-tuned based on various tests of inference accuracy for a given dictionary size R. If the resulting inference accuracy for inferences performed based on the dictionary D 120 and the corresponding coefficient matrices A 130 is below a threshold, the model may be fine-tuned using various techniques. For example, the model may be fine-tuned by updating various components (also called atoms) in the dictionary D 120 and the corresponding coefficient matrices A 130 until inference accuracy for the model reaches a threshold level.

In some aspects, the dictionary D 120 may be learned over the entirety of the machine learning model, as discussed above. In some aspects, however, a family of smaller dictionaries D₁, . . . , Dₙ may be learned. In such a case, the family of smaller dictionaries may have more representational power than a unitary dictionary D learned over the entirety of the machine learning model. These smaller dictionaries may be split, for example, on a per-attention-head basis (e.g., with a discrete dictionary learned for each head in a multi-head attention component of a transformer-based machine learning model), based on tiling across different processing units (e.g., cores, processors, etc.) on which a machine learning model executes, or the like.

In some aspects, the weight matrix W 110 may be column-normalized while generating the dictionary D 120 and coefficient matrices A 130. In column-normalizing the weight matrix W 110, values within each column may be normalized between a defined minimum value and a defined maximum value, which may allow for the use of smaller data types within the weight matrix W 110 and thus correspondingly allow for the use of smaller data types within the dictionary D 120 and the coefficient matrix A 130. A scaling factor that allows for the actual values of each point in the column may be generated and stored as an additional variable for use in generating inferences using the machine learning model.

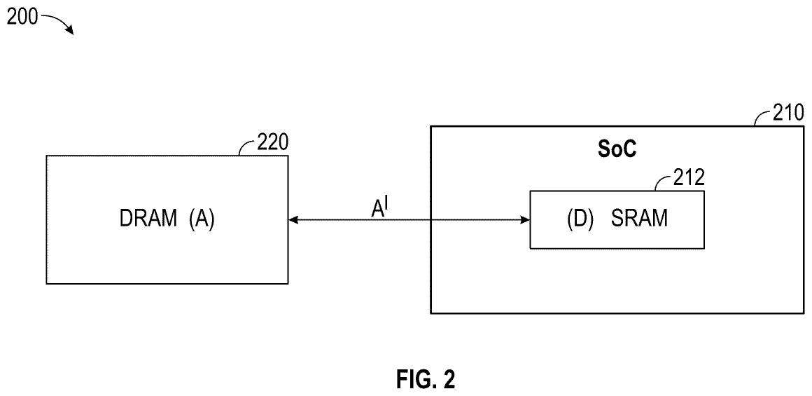

FIG. 2 illustrates an example 200 of swapping of coefficient matrices between on-processor and off-processor memory, according to aspects of the present disclosure.

As discussed above, the decomposition of a weight matrix W 110 into a smaller dictionary D 120 and a coefficient matrix (or multiple coefficient matrices) A 130 generally allows the storage of the dictionary D 120 in on-processor memory (e.g., an SRAM 212 on a processor 210 (labeled as a system-on-chip (SoC), though it should be recognized that any sort of processor including on-processor memory may be contemplated in the example 200). That is, when inferencing operations are initiated, the dictionary D 120 may be loaded into the SRAM 212 and need not be unloaded from the SRAM 212 until inferencing operations are completed. During inferencing operations, the appropriate coefficient matrix A^{l} may be swapped into the SRAM 212 (or other on-processor memory component) from a DRAM 220 (or other off-processor memory component on which coefficient matrices can be stored).

In the example 200, the number of weights moved from the DRAM 220 to the SRAM 212 for each iteration of swapping (e.g., execution of each layer in the machine learning model) for inference operations involving a generative artificial intelligence network using multi-headed attention self-attention and a two-layer feedforward network with non-gated-linear-unit nonlinearities may be reduced from 12×L×dₘ² to 12×L×N×dₘ, where N represents the average number of non-zero coefficients in the columns of the coefficient matrix A. This reduction of the number of weights generally allows for the memory bandwidth between the SRAM 212 and the DRAM 220 to be compressed at a ratio of

$$\frac{{d}_{m}}{N} .$$

For example, in a machine learning model with a dimensionality of 1024 and N=96 (e.g., where there is an average of 32 non-zero coefficients in the coefficient matrix A 130), the bandwidth compression ratio may be 10.7: that is, relative to swapping the entirety of a weight matrix W 110 into and out of the SRAM 212, the amount of bandwidth used to swap coefficient matrices A^{l} into and out of the SRAM 212 may be reduced by a factor of 10.7. In doing so, the amount of time in which the processor 210 is idle (e.g., executes no-operation instructions while waiting for the appropriate coefficient matrices A^{l} to be swapped into and out of the SRAM 212) may be significantly reduced.

At the processor 210, an output of a portion of the machine learning model (e.g., an output of a specific layer of the machine learning model, also referred to herein as an “intermediate output” in the machine learning model) may be generated by multiplying an input (e.g., an input provided into the model for processing or an intermediate output generated by a prior layer in the machine learning model) by the dictionary D 120 and then by the appropriate coefficient matrix A 130. In doing so, the computational expense involved in performing inferencing operations may be increased; however, in machine learning model deployments in which performance is bandwidth-limited, reductions in memory overhead may allow for increased model throughput that outweighs the increased computational expense involved in performing an additional multiplication operation on the data provided as input into the machine learning model.

### Example Operations for Inferencing Using Machine Learning Models with Dense Weight Matrices Decomposed into a Dictionary and a Coefficient Matrix

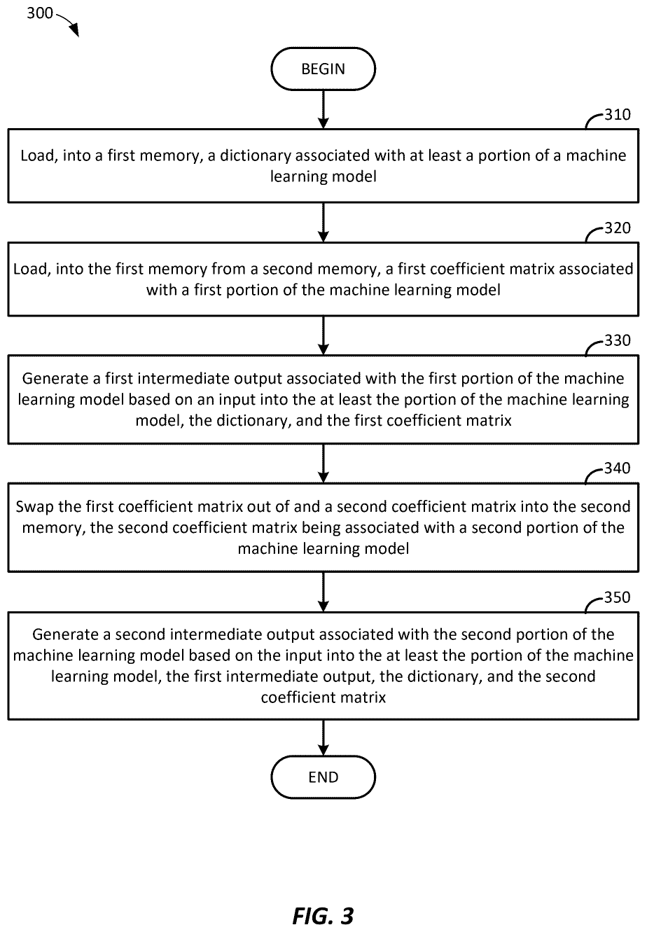

FIG. 3 illustrates example operations 300 that may be performed by a computing device to generate an inference using a machine learning model with a dense weight matrix decomposed into a dictionary and a coefficient matrix, according to aspects of the present disclosure. The computing device for performing the operations 300 may be a device on which a machine learning model, such as a generative artificial intelligence model, can be deployed, such as a smartphone, a tablet computer, a laptop computer, a desktop, a server, a cloud compute instance hosted in a distributed computing environment, or the like.

As illustrated, the operations 300 begin at block 310, with loading, into a first memory, a dictionary associated with at least a first portion of a machine learning model.

At block 320, the operations 300 proceed with loading, into the first memory from a second memory, a first coefficient matrix. The first coefficient matrix may be associated with a first portion of the machine learning model.

At block 330, the operations 300 proceed with generating a first intermediate output associated with the first portion of the machine learning model based on an input into the at least the portion of the machine learning model, the dictionary, and the first coefficient matrix.

At block 340, the operations 300 proceed with swapping the first coefficient matrix out of and a second coefficient matrix into the second memory. The second coefficient matrix may be associated with a second portion of the machine learning model.

At block 350, the operations 300 proceed with generating a second intermediate output associated with the second portion of the machine learning model based on the input into the at least the portion of the machine learning model, the first intermediate output, the dictionary, and the second coefficient matrix.

In some aspects, the sum of the size of the dictionary and the size of the first coefficient matrix may have an upper bound equal to the size of the first memory. By upper bounding the size of the dictionary and first coefficient matrix based on the size of the first memory, certain aspects of the present disclosure may allow for the dictionary and the first coefficient matrix to be contained in the first memory without swapping data into and out of memory during inferencing operations using the first coefficient matrix (e.g., inferencing operations associated with a first portion of the machine learning model, such as a first layer in a multi-layer machine learning model).

In some aspects, the first coefficient matrix is associated with an attention head in the machine learning model.

In some aspects, the first coefficient matrix is associated with a layer of the machine learning model.

In some aspects, the first memory may comprise a memory collocated with a processor, and the second memory may comprise a memory remote from the processor. For example, the first memory may be static random access memory (SRAM) collocated with the processor and used as a cache for the processor. The second memory, meanwhile, may be dynamic random access memory (DRAM) in which data is temporarily stored during inferencing operations, nonvolatile random access memory (NVRAM) which can flexibly be used as random access memory or persistent memory, persistent storage devices (e.g., hard disk drives, solid state drives, or other storage devices on which a swap file can be stored for use as extended memory), or the like.

In some aspects, the dictionary may be an overcomplete dictionary. As discussed, an overcomplete dictionary may include a number of dictionary vectors that exceeds the number of vectors called for to uniquely represent an N-dimensional vector, where N corresponds to an average number of non-zero entries in each column of a coefficient matrix.

In some aspects, the dictionary may include a plurality of sub-dictionaries. Each respective sub-dictionary may be associated with a respective portion of the machine learning model. During inferencing operations, the appropriate sub-dictionary may be combined with a corresponding coefficient vector to recover a weight matrix for a specific portion of the machine learning model.

In some aspects, the dictionary may be a column-normalized dictionary. To generate the first intermediate output, a normalization scaling factor associated with the column-normalized dictionary may further be used.

In some aspects, the dictionary may be a low-rank decomposition of one or more matrices defining the at least the portion of the machine learning model. In one example, the low-rank decomposition of the one or more matrices defining the at least the portion of the machine learning model comprises a singular value decomposition of the one or more matrices defining the at least the portion of the machine learning model. In one example, the dictionary comprises a sparse decomposition of the low-rank decomposition of the one or more matrices defining the at least the portion of the machine learning model. It should be recognized that various techniques for decomposing the one or more matrices defining the at least the portion of the machine learning model may be used alone or in combination in order to generate the dictionary.

In some aspects, a matrix product of the dictionary and the first coefficient matrix comprises a weight matrix associated with the first portion of the machine learning model.

In some aspects, the first coefficient matrix comprises a sparse coefficient matrix.

### Example Processing Systems for Efficient Execution of Inference Operations Using Weight Matrices Decomposed into a Dictionary and a Coefficient Matrix

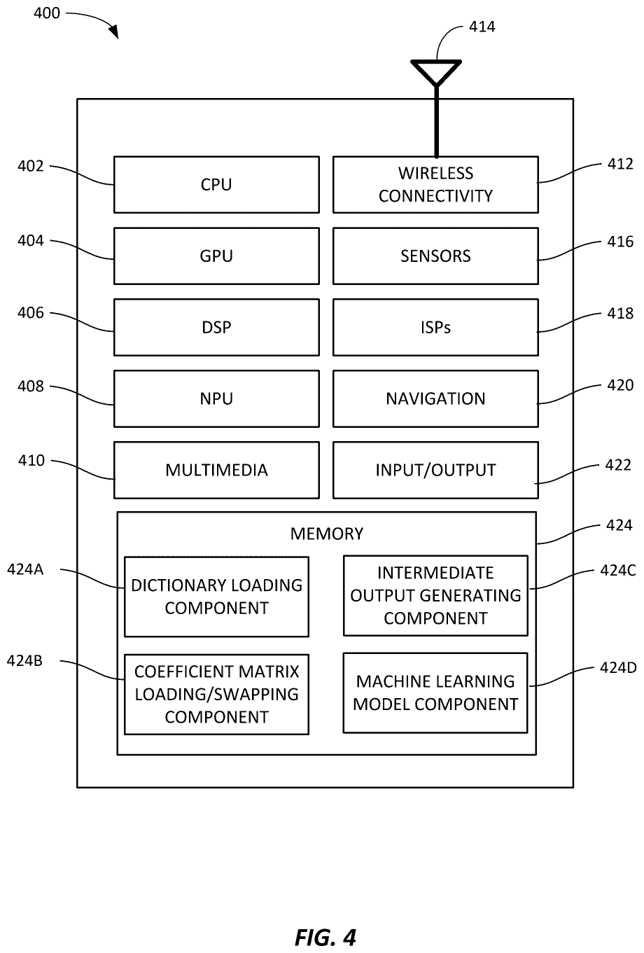

FIG. 4 depicts an example processing system 400 for executing inferencing operations using a machine learning model based on a weight matrix decomposed into a dictionary and a coefficient matrix, such as described herein for example with respect to FIG. 3. These inferencing operations may include, for example, the generation of responses to queries input into a generative artificial intelligence model or other operations with performance that may be memory bandwidth-constrained.

The processing system 400 includes a central processing unit (CPU) 402, which in some examples may be a multi-core CPU. Instructions executed at the CPU 402 may be loaded, for example, from a program memory associated with the CPU 402 or may be loaded from a memory partition (e.g., of memory 424).

The processing system 400 also includes additional processing components tailored to specific functions, such as a graphics processing unit (GPU) 404, a digital signal processor (DSP) 406, a neural processing unit (NPU) 408, and a connectivity component 412.

An NPU, such as the NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 408 is a part of one or more of the CPU 402, the GPU 404, and/or the DSP 406. These may be located on a user equipment (UE) in a wireless communication system or another computing device.

In some examples, a connectivity component 412 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 412 may be further coupled to one or more antennas 414.

The processing system 400 may also include one or more sensor processing units 416 associated with any manner of sensor, one or more image signal processors (ISPs) 418 associated with any manner of image sensor, and/or a navigation processor 420, which may include satellite-based positioning system components (e.g., GPS or GLONASS) as well as inertial positioning system components.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

The processing system 400 also includes a memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes a dictionary loading component 424A, a coefficient matrix loading/swapping component 424B, an intermediate output generating component 424C, and a machine learning model component 424D. The depicted components, and others not depicted, may be configured to perform various aspects of the methods described herein.

Generally, the processing system 400 and/or components thereof may be configured to perform the methods described herein.

### Example Clauses

Implementation details of various aspects of the present disclosure are described in the following numbered clauses:

Clause 1: A processor-implemented method, comprising: loading, into a first memory, a dictionary associated with at least a portion of a machine learning model; loading, into the first memory from a second memory, a first coefficient matrix associated with a first portion of the machine learning model; generating a first intermediate output associated with the first portion of the machine learning model based on an input into the at least the portion of the machine learning model, the dictionary, and the first coefficient matrix; swapping the first coefficient matrix out of and a second coefficient matrix into the second memory, the second coefficient matrix being associated with a second portion of the machine learning model; and generating a second intermediate output associated with the second portion of the machine learning model based on the input into the at least the portion of the machine learning model, the first intermediate output, the dictionary, and the second coefficient matrix.

Clause 2: The method of Clause 1, wherein a sum of a size of the dictionary and a size of the first coefficient matrix has an upper bound equal to a size associated with the first memory.

Clause 3: The method of Clause 1 or 2, wherein the first coefficient matrix is associated with an attention head in the machine learning model.

Clause 4: The method of any of Clauses 1 through 3, wherein the first coefficient matrix is associated with a layer of the machine learning model.

Clause 5: The method of any of Clauses 1 through 4, wherein the first memory comprises a memory collocated with a processor and wherein the second memory comprises a memory remote from the processor.

Clause 6: The method of any of Clauses 1 through 5, wherein the dictionary comprises an overcomplete dictionary.

Clause 7: The method of any of Clauses 1 through 6, wherein the dictionary comprises a plurality of sub-dictionaries, each respective sub-dictionary being associated with a respective portion of the machine learning model.

Clause 8: The method of any of Clauses 1 through 7, wherein the dictionary comprises a column-normalized dictionary, and wherein generating the first intermediate output is further based on a normalization scaling factor associated with the column-normalized dictionary.

Clause 9: The method of any of Clauses 1 through 8, wherein the dictionary comprises a low-rank decomposition of one or more matrices defining the at least the portion of the machine learning model.

Clause 10: The method of Clause 9, wherein the low-rank decomposition of the one or more matrices defining the at least the portion of the machine learning model comprises a singular value decomposition of the one or more matrices defining the at least the portion of the machine learning model.

Clause 11: The method of Clause 9 or 10, wherein the dictionary comprises a sparse decomposition of the low-rank decomposition of the one or more matrices defining the at least the portion of the machine learning model.

Clause 12: The method of any of Clauses 1 through 11, wherein a matrix product of the dictionary and the first coefficient matrix comprises a weight matrix associated with the first portion of the machine learning model.

Clause 13: The method of any of Clauses 1 through 12, wherein the first coefficient matrix comprises a sparse coefficient matrix.

Clause 14: The method of any of Clauses 1 through 13, wherein the first memory comprises static random-access memory (SRAM) and wherein the second memory comprises dynamic random-access memory (DRAM).

Clause 15: A processing system, comprising: at least one memory having executable instructions stored thereon; and one or more processors configured to execute the executable instructions in order to cause the processing system to perform the operations of any of Clauses 1 through 14.

Clause 16: A processing system, comprising means for performing the operations of any of Clauses 1 through 14.

Clause 17: A non-transitory computer-readable medium having executable instructions stored thereon which, when executed by one or more processors, perform the operations of any of Clauses 1 through 14.

Clause 18: A computer program product having executable instructions stored thereon which, when executed by one or more processors, perform the operations of any of Clauses 1 through 14.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon;
a first memory;
a second memory; and
one or more processors configured to execute the executable instructions to cause the processing system to:
load, into the first memory, a dictionary associated with at least a portion of a machine learning model;
load, into the first memory from the second memory, a first coefficient matrix associated with a first portion of the machine learning model;
generate a first intermediate output associated with the first portion of the machine learning model based on an input into the at least the portion of the machine learning model, the dictionary, and the first coefficient matrix;
swap the first coefficient matrix out of and a second coefficient matrix into the second memory, the second coefficient matrix being associated with a second portion of the machine learning model; and
generate a second intermediate output associated with the second portion of the machine learning model based on the input into the at least the portion of the machine learning model, the first intermediate output, the dictionary, and the second coefficient matrix.

2. The processing system of claim 1, wherein a sum of a size of the dictionary and a size of the first coefficient matrix has an upper bound equal to a size associated with the first memory.

3. The processing system of claim 1, wherein the first coefficient matrix is associated with an attention head in the machine learning model.

4. The processing system of claim 1, wherein the first coefficient matrix is associated with a layer of the machine learning model.

5. The processing system of claim 1, wherein the first memory comprises a memory collocated with at least one of the one or more processors and wherein the second memory comprises a memory remote from the at least one of the one or more processors.

6. The processing system of claim 1, wherein the dictionary comprises an overcomplete dictionary.

7. The processing system of claim 1, wherein the dictionary comprises a plurality of sub-dictionaries, each respective sub-dictionary being associated with a respective portion of the machine learning model.

8. The processing system of claim 1, wherein the dictionary comprises a column-normalized dictionary, and wherein generating the first intermediate output is further based on a normalization scaling factor associated with the column-normalized dictionary.

9. The processing system of claim 1, wherein the dictionary comprises a low-rank decomposition of one or more matrices defining the at least the portion of the machine learning model.

10. The processing system of claim 9, wherein the low-rank decomposition of the one or more matrices defining the at least the portion of the machine learning model comprises a singular value decomposition of the one or more matrices defining the at least the portion of the machine learning model.

11. The processing system of claim 9, wherein the dictionary comprises a sparse decomposition of the low-rank decomposition of the one or more matrices defining the at least the portion of the machine learning model.

12. The processing system of claim 1, wherein a matrix product of the dictionary and the first coefficient matrix comprises a weight matrix associated with the first portion of the machine learning model.

13. The processing system of claim 1, wherein the first coefficient matrix comprises a sparse coefficient matrix.

14. The processing system of claim 1, wherein the first memory comprises static random-access memory (SRAM) and wherein the second memory comprises dynamic random-access memory (DRAM).

15. A processor-implemented method, comprising:
loading, into a first memory, a dictionary associated with at least a portion of a machine learning model;
loading, into the first memory from a second memory, a first coefficient matrix associated with a first portion of the machine learning model;
generating a first intermediate output associated with the first portion of the machine learning model based on an input into the at least the portion of the machine learning model, the dictionary, and the first coefficient matrix;
swapping the first coefficient matrix out of and a second coefficient matrix into the second memory, the second coefficient matrix being associated with a second portion of the machine learning model; and
generating a second intermediate output associated with the second portion of the machine learning model based on the input into the at least the portion of the machine learning model, the first intermediate output, the dictionary, and the second coefficient matrix.

16. The method of claim 15, wherein a sum of a size of the dictionary and a size of the first coefficient matrix has an upper bound equal to a size associated with the first memory.

17. The method of claim 15, wherein the first coefficient matrix is associated with an attention head in the machine learning model.

18. The method of claim 15, wherein the first coefficient matrix is associated with a layer of the machine learning model.

19. The method of claim 15, wherein the first memory comprises a memory collocated with a processor and wherein the second memory comprises a memory remote from the processor.

20. The method of claim 15, wherein the dictionary comprises an overcomplete dictionary.

21. The method of claim 15, wherein the dictionary comprises a plurality of sub-dictionaries, each respective sub-dictionary being associated with a respective portion of the machine learning model.

22. The method of claim 15, wherein the dictionary comprises a column-normalized dictionary, and wherein generating the first intermediate output is further based on a normalization scaling factor associated with the column-normalized dictionary.

23. The method of claim 15, wherein the dictionary comprises a low-rank decomposition of one or more matrices defining the at least the portion of the machine learning model.

24. The method of claim 23, wherein the low-rank decomposition of the one or more matrices defining the at least the portion of the machine learning model comprises a singular value decomposition of the one or more matrices defining the at least the portion of the machine learning model.

25. The method of claim 23, wherein the dictionary comprises a sparse decomposition of the low-rank decomposition of the one or more matrices defining the at least the portion of the machine learning model.

26. The method of claim 15, wherein a matrix product of the dictionary and the first coefficient matrix comprises a weight matrix associated with the first portion of the machine learning model.

27. The method of claim 15, wherein the first coefficient matrix comprises a sparse coefficient matrix.

28. The method of claim 15, wherein the first memory comprises static random-access memory (SRAM) and wherein the second memory comprises dynamic random-access memory (DRAM).

29. A processing system, comprising:
means for loading, into a first memory, a dictionary associated with at least a portion of a machine learning model;
means for loading, into the first memory from a second memory, a first coefficient matrix associated with a first portion of the machine learning model;
means for generating a first intermediate output associated with the first portion of the machine learning model based on an input into the at least the portion of the machine learning model, the dictionary, and the first coefficient matrix;
means for swapping the first coefficient matrix out of and a second coefficient matrix into the second memory, the second coefficient matrix being associated with a second portion of the machine learning model; and
means for generating a second intermediate output associated with the second portion of the machine learning model based on the input into the at least the portion of the machine learning model, the first intermediate output, the dictionary, and the second coefficient matrix.

30. A non-transitory computer-readable medium having executable instructions stored thereon which, when executed by one or more processors, perform an operation comprising:
loading, into a first memory, a dictionary associated with at least a portion of a machine learning model;
loading, into the first memory from a second memory, a first coefficient matrix associated with a first portion of the machine learning model;
generating a first intermediate output associated with the first portion of the machine learning model based on an input into the at least the portion of the machine learning model, the dictionary, and the first coefficient matrix;
swapping the first coefficient matrix out of and a second coefficient matrix into the second memory, the second coefficient matrix being associated with a second portion of the machine learning model; and
generating a second intermediate output associated with the second portion of the machine learning model based on the input into the at least the portion of the machine learning model, the first intermediate output, the dictionary, and the second coefficient matrix.
